(19) United States
(12) Patent Application Publication
(10) Pub. No.: US 2012/0100379 A1
(43) Pub. Date: Apr. 26, 2012

(54) FLUOROELASTOMER BONDING COMPOSITIONS SUITABLE FOR HIGH-TEMPERATURE APPLICATIONS

(75) Inventors: Jiazhong Luo, Lansdale, PA (US); Brian Ux, Red Hill, PA (US); Eugene Gurevich, Coopersburg, PA (US)

(73) Assignee: Greene, Tweed of Delaware, Inc., Wilmington, DE (US)

(21) Appl. No.: 13/276,290

(22) Filed: Oct. 18, 2011

Related U.S. Application Data
(60) Provisional application No. 61/405,102, filed on Oct. 20, 2010.

(51) Int. Cl. B32B 27/04; B32B 38/00; C09J 4/02; C09J 163/00; C09J 11/06

(52) U.S. Cl. 428/421; 523/400; 523/454; 156/242

(57) ABSTRACT

Bonding compositions are provided herein for bonding a curable fluoroelastomer composition, and preferably a perfluoroelastomer composition, to a substrate during a heat curing process. The compositions include (a) a compound selected from the group consisting of aluminum acrylates, silicon acrylates, ammonia acrylates, and combinations thereof, (b) an adhesive compound; and (c) a solvent. Methods of bonding fluoro- and perfluoroelastomers to a substrate surface are also including herein which utilize the bonding compositions.

### CROSS-REFERENCE TO RELATED APPLICATIONS

This application claims the benefit under 35 U.S.C. §119(e) to U.S. Provisional Patent Application No. 61/405,102, filed Oct. 20, 2010, the entire disclosure of which is incorporated herein by reference.

### BACKGROUND OF THE INVENTION

1. Field of the Invention

The invention relates to the field of bonding of fluoroelastomeric materials, including perfluoroelastomeric materials, to surfaces, including metallic surfaces which may be used in semiconductor manufacturing processes.

2. Description of Related Art

Semiconductor manufacturing involves the use of various sealed process chambers, and may involve cleanroom environments designed to avoid contamination and particulation that can impact the resulting manufactured products (semiconductor wafers and chips). Such process equipment typically includes gates and doors, e.g., slit valve doors, which close off the chambers from the surrounding environment. Such doors and gates generally include seals, gaskets and o-rings. The materials used to make such seals, gaskets and o-rings are usually formed of a fluoropolymeric or fluoroelastomeric material, and in some cases for highly contamination resistant seals, are formed of perfluoroelastomeric material. Such doors and gates are commonly used with process reaction chambers in the semiconductor industry allowing for opening and closing of a chamber.

In the semiconductor industry, processes such as chemical vapor deposition, plasma deposition, etching and the like are typically used. Such processes require the use of vacuum chambers and similar reactors in which harsh chemicals, high-energy plasmas and other corrosive materials are used creating very harsh environments. Plasmas are defined as a fourth state of matter distinct from solid, liquid or gas and are present in stars and fusion reactors. Gases become plasmas when they are heated until the atoms lose all their electrons, leaving a highly electrified collection of nuclei and free electrons.

Semiconductor process steps generally occur in an isolated environment in a series of interconnecting reaction and other chambers through which chips, chip wafers and other substrates can move or be moved robotically. When moving about and through such a series of chambers, in operation, there are also associated with this equipment various doors, gates, and/or valves. One such door includes a slit valve, which are made typically so as to have a resilient sealing ring that ensures adequate sealing of openings to a reaction chamber. Such sealing is important due to the harsh nature of the reactants within the chamber, i.e., to keep such chemicals safely within the chamber and to keep impurities from outside the chamber from getting in during a reaction which could impact the purity of the resulting reaction product(s).

Such parts can also be provided ready to use, such as providing a slit valve door or gate with a seal or gasket already in place on the door, such as in a pre-molded groove or gland sized to receive a seal, gasket or O-ring of corresponding shape in facing engagement. Thus, the doors or gates can be easily installed on the process equipment. Such seals can be bonded in place, but are not typically “sealed” properly to the door surface without use of a bonding agent, although self-bonding compositions have been developed.

Fluorine-containing elastomers (known as FKMs), are used in such seals in various environments requiring resistance to harsh chemicals. In the semiconductor area, it is particularly common to use perfluoroelastomers (known as FFKMs) to exhibit excellent chemical resistance, solvent resistance and heat resistance, and therefore such elastomers are widely used for sealing materials when in place in the harshest of environments. Perfluoroelastomeric materials are known for their chemical resistance, plasma resistance, and when used in compositions having typical filler or reinforcing systems for acceptable compression set resistance levels and mechanical properties. As such, they have been applied for many uses, including for use as elastomeric sealing materials in applications where a seal or gasket will be subject to highly corrosive chemicals and/or extreme operating conditions, and for use in forming molded parts that are capable of withstanding deformation.

FFKMs are well known for use in the semiconductor manufacturing industry as sealing materials due to their chemical and plasma resistance. Such materials are typically prepared from perfluorinated monomers, including at least one perfluorinated cure site monomer. The monomers are polymerized to form a perfluorinated polymer having the cure sites from the cure site monomer(s) and then cured (cross-linked) to form an elastomer. Typical FFKM compositions include a polymerized perfluoropolymer as noted above, a curing agent that reacts with the reactive cure site group on the cure site monomer, and any desired fillers. The cured perfluoroelastomer exhibits typical elastomeric characteristics.

FFKMs are generally known for use as O-rings and related sealing parts for high-end sealing applications due to their high purity, excellent resistance to heat, plasma, chemicals and other harsh environments. Industries that require their use in such environments include semiconductor, aerospace, chemical and pharmaceutical.

As is recognized in the art, different FFKM compositions may include different curing agents (curatives) depending on the type of cure site monomer (CSM) structure and corresponding curing chemistry. Such compositions may also include a variety of fillers and combinations of fillers to achieve target mechanical properties, compression set or improved chemical and plasma resistance. However, due to their largely inert chemical nature, it is not always easy to bond such FKM and FFKM materials to surfaces for forming ready-to-use parts such as gates, valves and other doors having seals pre-set therein or even to bond such seals in situ prior to use or in replacement of prior gate or door seals. There are many instances, however, when such bonded fluoroelastomer parts are put into service in the semiconductor industry in particular wherein the conditions of harsh plasma and other gases and/or the range of temperatures are not ideal for most bonding agents. For example, as temperatures reach levels of up to about 300° C., as occurs in many such applications, with some high temperature operations requiring seal performance as high as 380° C., bonding agents do not all maintain their bonding strength. Even standard FFKMs can melt at temperatures over 300° C., such that in more demanding processing, specialty FFKM compositions are developed. As these more demanding conditions develop and FFKM chemistry develops to meet the demand, the bonding agent technology must develop to continue to allow for such FKM and FFKM parts to be used in various demanding end applications. Finding bonding agents that can perform in high temperature, harsh condition processes is a challenge.

In some processes where very high temperatures are used and/or where specialty FFKMs are used, such as those having a higher content of tetrafluoroethylene (TFE), even when one can find a material resistant to the heat, the bonding agent must also be able to withstand the increased non-stick and inertness properties of an FFKM having higher levels of TFE in a consistent manner. While not all bonding agents, such as those on gates and some doors are exposed to the high temperatures, the need still exists for bonding agents which are readily bondable to the inertness of various FFKMs including those with high TFE content and in developing bonding agents that, even at room temperature, providing enhanced bonding strength.

In preparing FKM and FFKM seals, gaskets and O-rings for use in a part, where bonding is desired, the bonding material and the surface material must adhere or otherwise be affixed to one another. Typical surfaces to which such materials are bonded include other fluoroelastomers, perfluoroelastomers or other fluoropolymers (e.g., in molding parts together, welding or splicing elastomers, or adhering fluoroelastomers to fluoropolymeric materials), metals, metal alloys, an/or other thermosetting or thermoplastic resins (such as resins suitable for use in harsh or pure environments in which FKMs or FFKMs may be put into service—semiconductor manufacturing, medical sterilization use, pharmaceutical manufacturing, and downhole tool use).

While the inert nature of fluoroelastomers (including perfluoroelastomers) is a benefit in harsh and pure environments, it presents difficulty in the fabrication of the bonded parts where the elastomer is bonded to a surface, such as in semiconductor processing gates, valves, and doors. Because of its inertness, it is difficult to achieve surface-to-elastomer bonds, such as metal-to-FFKM bonds, of sufficient strength and durability that the bond will survive in the environment for a sufficient period of time before requiring replacement or repair. Thus difficulties are encountered in bonding and consistently holding a good bond when using FFKM parts formed from FFKMs with higher TFE content and/or when subjecting such parts to high temperature processes.

In elastomer vulcanization and bonding processes, bonding agents are known which are manually applied with brushes onto a substrate followed by molding and post-curing of the elastomer part. Standard bonding agents, include, for example, those available from Lord Chemical, Cary, N.C. under the trade name Chemlok®. The resulting bonding products face challenges in surviving at processing or other application temperatures above 200° C. Use at up to about 300° C. or even 380° C. or higher for some application temperatures of over 200° C. is not possible. Newer FFKMs and other elastomer products cure at temperatures which are high. Use of traditional bonding agents can cause bonded parts to delaminate during post-curing. Bonding agents which can retain integrity at 200° C.+and particularly at about 250° C. to about 300° C. and higher in longer continued use at sustained high temperatures are very much sought after in the semiconductor and adhesive industries for high temperature service elastomers.

U.S. Pat. No. 6,194,504 discloses a process for compounding metal salts into elastomers such that metal acrylate salts are used therein as scorch retarders.

U.S. Pat. No. 5,217,807 teaches a reinforced natural or synthetic rubber or blended rubber composition, which includes sulfur-curable elastomers with metallic fillers. Brass coated metal reinforcement blended in the elastomer is provided which may include metal acrylates as an adhesion promoter.

U.S. Pat. No. 7,514,506 B2 discloses perfluoroelastomeric compositions which may be used for bonding to a metallic surface, such as in a gate valve. The compositions include curable perfluoropolymers curable with diphenyl-based curing agents, including bisaminophenol (BOAP), curing agents, and organic cyclic colorant compounds that are metallic-free materials.

U.S. Patent Application Publication No. 2009/0018275 A1 teaches use of FFKM solvent formulations including both curable perfluoropolymers and curing agents in a solvent solution which are used as bonding agents for bonding perfluoropolymers to surfaces, such as to other perfluoropolymer surfaces, and a curable solvent coating composition capable of forming an FFKM coating for bonding to, for example, a metallic surface.

U.S. Publication No. 2009/0301712 A1 teaches FKM and FFKM compositions for use in harsh environments, particularly for down-hole tool use, that bond to substrates, including, e.g., metal and polymeric inert substrates. The compositions include a curable fluoropolymer, silica and an acrylate compound, and preferably a curing agent. The acrylates are described as metal acrylates or combinations of differing acrylate compounds and/or metal acrylates. Exemplary compounds listed are diacrylates, methacrylates, dimethacrylates, triacrylates, and/or tetraacrylates, and of particular use are those diacrylates and methacrylates of the heavy metals, zinc and copper. The publication notes that such compounds are known as commercial products available from, for example, Cray Valley (formerly from Sartomer) of Exton, Pa., United States of America (tradenames, for example, SARET® SR633 and SARET® SR634. Such resulting FKM and FFKM products are described as self-bonding materials.

An adhesive primer composition is described in U.S. Publication No. 2011/0143138 A1 for use in bonding FFKM materials to a substrate. The primer composition includes a solvent, a curative and an epoxide resin. The curative selected is either capable of curing the FFKM compound (which has a cure site and a crosslinking agent or catalyst) or when the curative does not cure the FFKM compound, the FFKM compound includes a crosslinking agent or a catalyst for curing the epoxide resin.

While various prior art compounds show a continued improvement in the art for increasingly better bonding agents, however, not all environments are the same. In semiconductor environments, there is a particular need for compositions of high bonding strength that are heavy-metal free and that improve upon the bond strength achievable from standard bonding agents and wherein such bonding can be maintained and perform effectively and consistently in high temperature and in harsh environments, while maintaining good bonding strength even in the face of the inert nature of the FFKMs, especially high-TFE content FFKMs being developed for high temperature use. Such compounds should enable strong bonds which strive to themselves be inert or non-interfering in the semiconductor process and allow for bonding to polymeric, elastomeric and particularly to metal surfaces for metals in doors, gates, and valves known in the semiconductor processing arts, while still exhibiting durable bond strength to inert materials and resisting delamination or melting in high temperatures of 150° C., 200° C., 300° C. or higher.

### BRIEF SUMMARY OF THE INVENTION

The invention provides a liquid bonding agent composition which is useful on FFKM products generally to bond to other FFKMs, metallic and other substrates, and suitable for use in bonded applications and end products employed in high temperature and plasma environments, such as those encountered in semiconductor processing.

The invention includes a bonding composition for bonding a curable fluoroelastomer composition to a substrate during a heat curing process, comprising a) a compound selected from the group consisting of aluminum acrylates, silicon acrylates, ammonia acrylates, and combinations thereof, b) an adhesive compound; and c) a solvent.

The adhesive compound may be one or more of epoxys, acrylates, urethanes, silicones, cyanoesters and combinations thereof. Epoxys and cyanoesters are most preferred. In a preferred embodiment, there is only one of the compound and it is an aluminum acrylate, a silicon acrylate, or an ammonia acrylate, and preferably the compound is aluminum acrylate. Further, it is preferred that a ratio of the compound to the adhesive in the composition is about 0.1:25 to about 2:1 parts by weight on a dry basis, and more preferably about 1:5 to about 1:1 parts by weight.

In one embodiment, the composition comprises about 20 to about 90 percent by weight solvent, preferably about 50 to about 90 percent by weigh solvent; about 0.04 to about 54 parts by weight of the compound, preferably about 1.5 to about 40 percent by weight of the compound, and most preferably about 1.5 to about 25 percent by weight of the compound; and about 3 to about 78 percent by weight of the adhesive compound, more preferably about 3 to about 67 percent by weight of the adhesive compound, and most preferably about 3 to about 42 percent by weight of the adhesive compound.

The composition is preferably heavy-metal free. It is preferred that the solvent be compatible with the compound and the adhesive.

The solvent may be a one or more of the following: acetone, methyl ethyl ketone, methyl isobutyl ketone, methanol, ethanol, propanol, fluorosolvents and the like, preferably a solvent that will sufficiently dissolve the aluminum into the bonding agent solution, and other similar materials, wherein preferably the solvent is vaporizable at temperatures of no greater than about 120° C.

In a further embodiment, the bonding composition is capable of bonding a fluoroelastomer composition to a substrate selected from the group consisting of ceramic, metals, metal alloys, semiconductors, polymers, and combinations thereof. In another embodiment, the bonding composition is preferably capable of bond a fluoroelastomer composition to alumina, sapphire, boron, silicon, germanium, arsenic, antimony, tellurium, polonium, anodized aluminum, aluminum, stainless steel, polytetrafluoroethylene, and combinations thereof.

In yet a further embodiment, the bonding composition is capable of bonding a fluoroelastomer composition to a substrate selected from the group consisting of ceramic, metals, metal alloys, semiconductors, polymers and combinations thereof. The fluoroelastomer composition preferably comprises a curable fluoroelastomer that has at least two monomers and at least one curesite monomer, wherein the at least two monomers comprise tetrafluoroethylene and vinylidene fluoride. The fluoroelastomer composition further preferably also comprises at least one curing agent, and optionally at least one of a second curing agent, a co-curing agent, and a cure accelerator. The fluoroelastomer may also comprise at least two curable fluoropolymers, wherein the at least two curable fluoropolymers may be in a blend. The fluoropolymer composition is preferably a perfluoropolymer composition and the least one curable fluoropolymer further preferably comprises at least one curable perfluoropolymer, and optionally at least one curing agent. In one embodiment, the curable perfluoropolymer comprises tetrafluoroethylene, a perfluoroalkylvinylether, and at least one curesite monomer, and it is within the scope of the invention further to include at least two curable perfluoropolymers, which such perfluoropolymers may be combined in a blend.

Perfluoropolymer compositions in such embodiments may comprise a first curable perfluoropolymer comprising tetrafluoroethylene, a first perfluoroalkylvinyl ether and at least one first cure site monomer having at least one cure site, wherein the tetrafluoroethylene is present in the first curable perfluoropolymer in an amount of at least about 60 mole percent; a second curable perfluoropolymer comprising tetrafluoroethylene, a second perfluoroalkylvinyl ether and at least one second cure site monomer having at least one cure site, wherein the second curable perfluoropolymer comprises fluoroplastic particles therein, and a curing agent. The first curable perfluoropolymer preferably comprises at least 60 to 95 mole percent tetrafluoroethylene.

The invention further includes a method of bonding a fluoroelastomer composition to a substrate, comprising, a) providing a curable fluoropolymer composition comprising at least one curable fluoropolymer; b) forming an article pre-form having an outer surface; c) providing a substrate having a bonding surface thereon; d) coating at least one of a portion of the outer surface of the article pre-form and at least a portion of the bonding surface of the substrate with a bonding composition comprising a compound selected from the group consisting of aluminum acrylates, silicon acrylates, ammonia acrylates, and combinations thereof; an adhesive compound; and a solvent; e) contacting the outer surface of the article pre-form and the substrate surface such that the bonding composition contacts at least a portion of the outer surface of the article pre-form and the substrate surface; and f) subjecting the article-pre-form and the substrate to heat and curing the fluoropolymer composition so as to bond the article pre-form to the substrate surface by way of the bonding composition and form a bonded structure having a fluoroelastomer bonded to the substrate.

In the method, the fluoroelastomer composition is preferably a perfluoroelastomer composition.

The method may further comprise g) post-curing the bonded structure.

Step b) of the method may further comprise providing a second substrate having a surface and in step f) heat molding the curable fluoropolymer composition to the surface of the first substrate and to the surface of the second substrate to form a bonded structure, wherein the fluoropolymer is at least partially bonded to the surfaces of the first and the second substrates. The bonded structure formed of such an embodiment may be a laminated structure.

The invention further includes a bonded structure, comprising: a) a substrate having a surface; and b) a fluoroelastomer bonded thereto, wherein the substrate and the fluoroelastomer are bonded by a bonding composition comprising a compound selected from the group consisting of aluminum acrylates, silicon acrylates, ammonia acrylates, and combinations thereof; an adhesive compound; and a solvent. Preferably in this embodiment, the fluoroelastomer is a perfluoroelastomer.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a longitudinal cross-sectional side view of a standard slit valve door taken along line A-A of FIG. 3;

FIG. 2 is an enlarged portion of the slit valve door of FIG. 1; and

FIG. 3 is a top plan view of a standard slit valve door having a seal bonded within a groove therein.

### DETAILED DESCRIPTION OF THE INVENTION

The invention herein provides a heavy-metal free compound that may be used for bonding fluoroelastomers to substrates in a variety of conditions from standard room temperature conditions to harsh and high-temperature environments, even for highly inert fluoroelastomer compositions. In semiconductor applications, many reaction chambers include interior walls, doors and other surfaces of, for example, anodized aluminum. The bonding compositions herein, provide a strong bond to a substrate surface for fluoroelastomer compositions capable of withstanding harsh environments and high temperature processes, even when the fluoroelastomer has a high TFE content.

The invention provides a new bonding composition and method for use in various high-temperature and/or harsh environments (such as semiconductor processing) to enable excellent bonding strength of fluoroelastomers, including perfluoroelastomers, to substrates and in a predictable manner. The resulting fluoroelastomer compositions when bonded to a surface by the bonding agents herein demonstrate excellent bonding strength and form a bond during curing of a curable fluoropolymer and retain good physical properties. The resulting compositions can provide bonded structures in which the elastomer component is benign enough for use in semiconductor applications, wherein such structures can include parts used in processing equipment, laminates, and other structures having a surface with the elastomer compositions bonded thereto.

The invention provides a liquid bonding agent composition which is useful on FKM and FFKM products generally to bond to other FKMs, FFKMs, metallic and other substrates, and suitable for use in bonded applications and end products employed in high temperature and plasma environments, such as those encountered in semiconductor processing.

The invention includes a bonding composition for bonding a curable fluoroelastomer composition to a substrate during a heat curing process, including (a) a compound selected from the group consisting of aluminum acrylates, silicon acrylates, ammonia acrylates, and combinations thereof, (b) an adhesive compound; and (c) a solvent.

The bonding compound(s) (a), noted above, useful as additives in the compositions herein include aluminum acrylates, silicon acrylates, ammonia acrylates, and combinations thereof. The acrylate portion of such aluminum acrylates, silicon acrylates and ammonia acrylates may be an acrylate, an alkyl acrylate, or a perfluorinated alkyl acrylate. It is preferred that the acrylate in the compounds is one of a monoacrylate, a diacrylate or a triacrylate, however, chain polymeric acrylates may also be used, provided the chain length does not interfere with incorporation of the compound into the curable FKM or FFKM. The acrylate is preferably a mono-, di-, tri-acrylate and the like. Such products can be used individually or in combinations.

Most preferred of these compounds is aluminum acrylate (also known as aluminum triacrylate, acrylic acid aluminum salt, and triacrylic acid aluminum salt; CAS 315743-20-1 having a molecular weight of about 243.17) is preferred and may be a commercial compound or compound synthesized having chemical formula Al(CH₂═CHCOO)₃. Exemplary commercial compounds available for such use are aluminum triacrylate, sold as Cray Valley® Product PRO-4302, available from Cray Valley Company Inc. of Exton Pa., and are available from Alfa Aesar as Product 42003. It is also available from Gelest, Inc. as aluminum acrylate. While these compounds are preferred, other materials of a similar chemical nature that perform well in such a composition may be used, provided bonding strength and performance are sufficiently retained.

The adhesive compound (b) may be any suitable adhesive that is capable of elastomer bonding. There are a wide variety of such materials available and commercially sold in industry as elastomer or rubber adhesives and can be any one of a number of materials, including one or more of epoxys, acrylates, urethanes, silicones, cyanoesters and combinations thereof The materials may be used as a standalone adhesive polymeric material to be incorporated into a solvent-based formulation to which the compound (a) is added, or may be purchased as a solvent-based formulation commercially available in a prepared form, to which the compound (a) may be incorporated. Preferably, such adhesive compound material is known or demonstrated to be capable of bonding fluoroelastomers or perfluoroelastomers or fluoroplastics. Suitable adhesive compounds are available from Dyneon (3M Corporation), Minnesota, under the name E-20524A and Dynamar™ RC 5130T. The latter compounds are available in prepared solvent-based formulations, and include other polymeric hardener additives (such as phenolic polymers, styrenic acrylate polymers and the like) and formulation additives as well (other solvents, diamines and the like for preservation, compatibilization, miscibility, solvating, UV protection, rheology or viscosity modification as is known in the art).

The compound (a) and the adhesive compound (b) are preferably used in a ratio of the compound to the adhesive in the composition of about 0.1:25 to about 2:1 parts by weight on a dry basis, and more preferably about 1:5 to about 1:1 parts by weight.

In bonding agent composition, the materials are preferably added so that the solvent is about 20 to about 90 percent by weight of the composition, and preferably about 50 to about 90 percent by weight of the composition. The compound is preferably about 0.04 to about 54 parts by weight, more preferably about 1.5 to about 40 percent by weight, and most preferably about 1.5 to about 25 percent by weight. The adhesive compound is preferably present in an amount of about 3 to about 78 percent by weight of the composition, more preferably about 3 to about 67 percent by weight, and most preferably about 3 to about 42 percent by weight.

The solvent may be a one or more of the following: acetone, methyl ethyl ketone, methyl isobutyl ketone, methanol, ethanol, propanol or other similar organic solvent materials, wherein preferably the solvent is vaporizable at temperatures of no greater than about 120° C. Note that the solvent used in embodiments herein may be a blend of other combination of solvents. Fluorosolvents may also be used such as fluorinated solvents, such as, Fluorinert® FC-40, FC-75 and FC-77, provided such solvents are used in amounts that do not impact the perfluoropolymer surfaces to which they are bonding.

Preferably, the solvent content is sufficient to provide a liquid flowable composition, however, the solvent may be kept low for various reasons and the composition more of a paste consistency if desired. The solvent may be about 20 to about 90 percent by overall weight of the composition, more preferably about 50 to about 90 percent by weight.

The composition is preferably heavy-metal free. It is preferred that the solvent be compatible with the compound and the adhesive. Additives may be provided to the bonding agent composition, including standard FFKM or FKM adhesive bonding agent or other adhesive additives so long as such additives do not materially impact performance in a negative manner, such as, for example, coupling agents, adhesion promoters, catalysts, curatives, co-curtives, cure accelerators, thixotropic or rheological additives, additional bonding agents, silanes, including alkoxy silanes and derivatives thereof, as are known in the art and/or sold for use with such compounds (see U.S. Publication No. 2011/0143138 A1, incorporated by reference in relevant part herein), or may include further additives suitable for use in FFKM or FKM compositions, including those listed in this disclosure below. Preferably such additives comprise no greater than about 30 percent by weight of the bonding agent composition, preferably no greater than about 20 weight percent, and most preferably about 0 to about 10 weight percent.

The curable fluoropolymer in the composition may be any suitable fluoropolymer, including those preferred compositions which are used in harsher environments such as semiconductor processing. The curable fluoropolymers may be standard non-perfluorinated fluoropolymers (FKMs) as are known in the art or perfluoropolymers (FFKMs), which are also known in the art and are more common for use in semiconductor processing applications. Standard FKM polymers in accordance with elastomer nomenclature, typically have at least two monomers, one of which is fluorinated, and preferably all of which are fluorinated to some degree, with at least one curesite monomer for use in vulcanization. The at least two monomers generally include tetrafluoroethylene and vinylidene fluoride, but may include a wide variety of other monomers. The fluoroelastomer composition may also include at least one curing agent that is capable of undergoing a crosslinking reaction with a functional group in the curesite monomer(s).

Such bonding compositions are intended for use with curable fluoroelastomer compositions that include curable fluoropolymers that cure to form a fluoroelastomers. Such a fluoroelastomer composition typically includes a curable fluoropolymer that has at least two monomers and at least one curesite monomer, wherein the curesite monomer has a reactive functional group to permit cross-linking. At least two of the monomers are preferably tetrafluoroethylene and vinylidene fluoride, but other typical monomers may be used in addition to these two for forming a variety of fluoropolymers known in the art. The fluoroelastomer composition may be radiation crosslinkable or crosslinkable (curable) through a cure system wherein a curing agent(s) is/are added that is capable of reacting with a functional group in the curesite monomer. Optionally, at least one of a second curing agent, a co-curing agent, and/or a cure accelerator(s) may be employed as well. The fluoroelastomer composition may have a single curable fluoropolymer or a combination of at least two curable fluoropolymers, in the form of, for example, a polymer blend, grafted composition or alloy.

The terms “uncured” or “curable,” refer to fluoropolymers or perfluoropolymers in compositions for use with the bonding agents herein, which have not yet been subjected to crosslinking reactions in any substantial degree such that the material is not yet sufficiently cured for the intended application.

The curable fluoropolymer and perfluoropolymer compositions for use with the bonding agents herein may optionally include additional such polymers in blend-like compositions or grafted/copolymerized compositions as noted above. Further, the polymer backbones may include a variety of curesite monomer(s) along the chain to provide one or more different functional groups for crosslinking. The compositions may also include curing agents and co-curing agents and/or accelerators to assist in the cross-linking reactions.

One or more curable fluoropolymers or perfluoroelastomers may be present in such compositions. Such polymers are themselves formed by polymerizing or co-polymerizing one or more fluorinated monomers. In perfluoropolymers, one or more perfluorinated monomers are polymerized to form the polymer. Various techniques known in the art (direct polymerization, emulsion polymerization and/or free radical initiated polymerization, latex polymerization, etc.) can be used to form such polymers.

In the case of a standard fluoropolymer, the fluoropolymer may be formed by polymerizing two or more monomers, preferably one of which is fluorinated or perfluorinated, such as, for example tetrafluoroethylene (TFE), vinylidene fluoride (VF2), hexafluoropropylene (HFP), and at least one monomers which is a cure site monomer to permit curing, i.e. at least one fluoropolymeric curesite monomer. A fluoroelastomer composition as described herein may include any suitable standard curable fluoroelastomeric fluoropolymer(s) (FKM) capable of being cured to form a fluoroelastomer, and one or more curing agents as described herein. Examples of suitable curable FKM fluoropolymers include those sold under the trade name Tecnoflon® (P457, P459, P757, P959/30M) available from Solvay Solexis, S.p.A., Italy. Other suppliers of such materials are Daikin Industries, Japan; Dyneon, (3M Corporation), Minnesota; and E.I. DuPont de Nemours & Company, Inc., Delaware, among others. Such FKM polymers are not fully fluorinated on the backbone of the polymer. They may also include a variety of fillers as described herein, including nano-sized fluoropolymers.

As used in this application, “perfluoroelastomer” or “cured perfluoroelastomer” unless otherwise indicated, includes any cured fluoroelastomeric material or composition that is formed by curing curable fluoropolymer(s) which are curable perfluoropolymer(s) such as the curable perfluoropolymers in the curable perfluoroelastomeric compositions described herein.

A “curable perfluoropolymer” (sometimes referred to in the art as a “perfluoroelastomer” or more appropriately a “perfluoroelastomer gum”) that may be used to form a cured perfluoroelastomer is a fluoropolymer material that is substantially completely fluorinated, which is preferably completely perfluorinated on its polymeric backbone. It will be understood, based on this disclosure, that some residual hydrogen may be present in some perfluoroelastomers within the crosslinks of those materials due to use of hydrogen as part of a functional crosslinking group. Cured materials, such as perfluoroelastomers are cross-linked polymeric structures.

The curable perfluoropolymers that are used in the fluoroelastomeric compositions, such as the preferred perfluoroelastomeric compositions to form cured perfluoroelastomers upon cure, are formed by polymerizing one or more perfluorinated monomers, one of which is preferably a perfluorinated cure site monomer having a “cure site,” which is a functional group to permit curing, wherein the functional group includes a reactive group that may not be perfluorinated. Two or more perfluoropolymers, and preferably at least one curative (curing agent), are combined herein in a composition that is then cured forming the resulting crosslinked, cured fluoroelastomeric compositions, and preferably perfluoroelastomeric compositions as described herein.

As used herein, the curable fluorine-containing elastomeric compositions may be perfluoroelastomeric compositions which are blended and combined compositions formed from two or more curable perfluoropolymers, each of which is formed by polymerizing two or more perfluorinated monomers, including at least one perfluorinated monomer which has at least one functional group (cure site) to permit curing, i.e. there is at least one cure site monomer. Such curable perfluoropolymer materials are also referred to generally as FFKMs in accordance with the American Standardized Testing Methods (ASTM) standardized rubber definitions and as described further herein.

In a preferred embodiment herein, the fluoropolymer composition is preferably a perfluoropolymer composition having at least one curable perfluoropolymer, and optionally at least one curing agent. In one embodiment, the curable perfluoropolymer is formed so as to include tetrafluoroethylene, a perfluoroalkylvinylether, and at least one curesite monomer. Two or more curable perfluoropolymers may be incorporated as noted above, such as in a blend, grafted or alloy composition.

Perfluoropolymer compositions in such embodiments may comprise a first curable perfluoropolymer comprising tetrafluoroethylene, a first perfluoroalkylvinyl ether and at least one first cure site monomer having at least one cure site, wherein the tetrafluoroethylene is present in the first curable perfluoropolymer in an amount of at least about 60 mole percent; a second curable perfluoropolymer comprising tetrafluoroethylene, a second perfluoroalkylvinyl ether and at least one second cure site monomer having at least one cure site, wherein the second curable perfluoropolymer comprises fluoroplastic particles therein, and a curing agent. The first curable perfluoropolymer preferably comprises at least 60 to 95 mole percent tetrafluoroethylene. However, various blends are contemplated as within the scope of the invention and useful with the bonding composition herein.

As used herein, a perfluoropolymer (which includes co-polymers and may have a number of monomers such as terpolymers, tetrapolymers and the like) is a polymeric composition that includes a curable perfluoropolymer formed by polymerizing two or more perfluorinated monomers, including at least one perfluorinated monomer that has at least one functional group to permit curing, i.e., at least one cure site monomer.

Such perfluoroelastomeric compositions preferably include two or more curable perfluoropolymers, preferably perfluoro-copolymers, at least one of which perfluoropolymers has a high content of tetrafluoroethylene (TFE) for high temperature use. Other suitable co-monomers may include other ethylenically unsaturated fluoromonomers. While both polymers preferably have TFE or another similar perfluorinated olefin monomer, at least one is a high-TFE perfluoropolymer. Each polymer also preferably has one or more perfluoroalkylvinyl ethers (PAVEs), which include alkyl or alkoxy groups that may be straight or branched and which may also include ether linkages, wherein preferred PAVEs for use herein include, for example, perfluoromethylvinyl ether (PMVE), perfluoroethylvinyl ether (PEVE), perfluoropropylvinyl ether (PPVE), perfluoromethoxyvinyl ether and other similar compounds, with especially preferred PAVEs being PMVE, PEVE and PPVE, and most preferred being PMVE which provides excellent mechanical strength to resulting articles formed from curing the curable compositions herein. The PAVEs may be used alone or in combinations of the above-noted PAVE types within the curable perfluoropolymers and in the ultimate curable compositions so long as the use is consistent with the invention as described herein.

Cure site monomers may be of a variety of types with preferred cure sites noted herein. Preferred cure sites preferably are those having a nitrogen-containing group, however, other cure site groups such as carboxyl groups, alkylcarbonyl groups, or halogenated groups having, e.g., iodine or bromine as well as other cure sites known in the art may also be used, particularly since additional curable perfluoropolymers beyond the first and second curable perfluoropolymers may be provided to the composition. Consequently, while the disclosure herein discusses a variety of preferred curatives (also referred to herein as crosslinking agents, curing agents), when additional cure sites known in the art are used, other curatives that are capable of curing such alternative cure sites may also be used. For example, organic peroxide-based curatives and co-curatives may be used with halogenated functional cure site groups. It is most preferred that both the first and the second perfluoropolymers include nitrogen-containing cure sites

Suitable perfluoropolymers may be those that meet the industry accepted definition of a perfluoroelastomer listed as an FFKM in ASTM V-1418-05 and, are may be, for example, terpolymers or tetrapolymers of TFE, PAVE, and have one or more perfluorinated cure site monomers that each incorporate a functional group to permit cross linking of the terpolymer, at least one of which is a cure site capable of being cured by the cure systems used in the practice of the invention.

Perfluoropolymers that may be used in the various embodiments of the invention include those that may be obtained from, for example, Daikin Industries, Inc.; Solvay Solexis; Dyneon (3M Corporation); E.I. du Pont de Nemours, Inc.; W. L. Gore; Federal State Unitary Enterprise S.V.; Lebedev Institute of Synthetic Rubber in Russia; and Nippon Mektron in Japan.

In yet further embodiments, exemplary cure site monomers include those listed below, most of which are PAVE-based in structure and have a reactive site. Although the polymers may vary, preferred structures are those having the following structure (A):

CF₂═CFO(CF₂CF(CF₃)O)ₘ(CF₂)ₙ—X¹ (A)

wherein m is 0 or an integer from 1 to 5, n is an integer from 1 to 5 and X¹ is a nitrogen-containing group, such as nitrile or cyano. However, carboxyl groups, alkoxycarbonyl groups or halogenated end groups may also be used as X¹. Most preferably the cure site monomer in either or both of the first and the second curable perfluoropolymers in the compositions herein is in accordance with (A) noted above, wherein m is 0 and n is 5. The cure sites or functional groups X¹ noted herein, e.g., nitrogen-containing groups, include the reactive sites for crosslinking when reacted with a curative. Compounds according to formula (A) may be used alone or in various, optional, combinations thereof. From a crosslinking perspective, it is preferred that the crosslinking functional group is a nitrogen-containing group, preferably a nitrile group.

Further examples of cure site monomers according to formula (A) include formulas (1) through (17) below:

CY₂═CY(CF₂)ₙ—X² (1)

wherein Y is H or F, n is an integer from 1 to about 8

CF₂═CFCF₂R_{f}²—X² (2)

wherein R_{f}² is (—CF₂)ₙ—, —(OCF₂)ₙ— and n is 0 or an integer from 1 to about 5

CF₂═CFCF₂(OCF(CF₃)CF₂)ₘ(OCH₂CF₂CF₂)ₙOCH₂CF₂—X² (3)

wherein m is 0 or an integer from 1 to about 5 and n is 0 or an integer of from 1 to about 5

CF₂═CFCF₂(OCH₂CF₂CF₂)ₘ(OCF(CF₃)CF₂)ₙOCF(CF₂) —X² (4)

wherein m is 0 or an integer from 1 to about 5, and n is 0 or an integer of from 1 to about 5

CF₂═CF(OCF₂CF(CF₃))ₘO(CF₂)ₙ—X² (5)

wherein m is 0 or an integer from 1 to about 5, and n is an integer of from 1 to about 8

CF₂═CF(OCF₂CF(CF₃))ₘ—X² (6)

wherein m is an integer from 1 to about 5

CF₂═CFOCF₂(CF(CF₃)OCF₂)ₙCF(—X²)CF₃ (7)

wherein n is an integer from 1 to about 4

CF₂═CFO(CF₂)ₙOCF(CF₃)—X² (8)

wherein n is an integer of from 2 to about 5

CF₂═CFO(CF₂)ₙ—(C₆H₄)—X² (9)

wherein n is an integer from 1 to about 6

CF₂═CF(OCF₂CF(CF₃))ₙOCF₂CF(CF₃)—X² (10)

wherein n is an integer from 1 to about 2

CH₂═CFCF₂O(CF(CF₃)CF₂O)ₙCF(CF₃)—X² (11)

wherein n is 0 or an integer from 1 to about 5

CF₂═CFO(CF₂CF(CF₃)O)ₘ(CF₂)ₙ═X² (12)

wherein m is 0 or an integer from 1 to about 4 and n is an integer of 1 to about 5

CH₂═CFCF₂OCF(CF₃)OCF(CF₃)—X² (13)

CH₂═CFCF₂OCH₂CF₂—X² (14)

CF₂═CFO(CF₂CF(CF₃)O)ₘCF₂CF(CF₃)—X² (15)

wherein m is an integer greater than 0

CF₂═CFOCF(CF₃)CF₂O(CF₂)ₙ—X² (16)

wherein n is an integer that is at least 1

CF₂═CFOCF₂OCF₂CF(CF₃))OCF₂—X² (17)

wherein X² can be a monomer reactive site subunit such as a nitrile (—CN), carboxyl (—COOH), an alkoxycarbonyl group (—COOR⁵, wherein R⁵ is an alkyl group of 1 to about 10 carbon atoms which may be fluorinated or perfluorinated), a halogen or alkylated halogen group (I or Br, CH₂I and the like). It is preferred that perfluorinated compounds having no hydrogen atoms in that portion of the backbone of the cure site monomer that will lie in the polymer backbone chain are used if excellent heat resistance is desired for the perfluoroelastomer resulting from curing the perfluoropolymers as well as for preventing decrease in molecular weight due to chain transfer when synthesizing the perfluoroelastomer by polymerization reaction. Further, compounds having a CF₂═CFO— structure are preferred from the viewpoint of providing excellent polymerization reactivity with TFE.

Suitable cure site monomers preferably include those having nitrogen-containing cure sites such as nitrile or cyano cure sites, for preferred crosslinking reactivity. However, cure sites (having multiple and varied backbones in addition to those noted above) and having carboxyl, alkoxycarbonyls, COOH and other similar cure sites known in the art and to be developed may also be used. The cure site monomers may be used alone or in varied combinations.

The bonding agents are suited for high temperature use, so a preferred high-TFE perfluoropolymer may be used in a perfluoropolymer composition as described herein. Such a perfluoropolymer preferably has a molar percentage of TFE in the perfluoropolymer compound that is at least about 50 mole percent, more preferably about 60 mole percent, most preferably about 70 mole percent or more. Use of about 60 mole percent to about 95 mole percent is acceptable herein for a variety of useful high-TFE perfluoropolymers. A most preferred monomer content is TFE/PAVE/Cure site monomer which is 69.4:30.2:0.43, although the precise monomer content may vary for different uses and effects. A variety of PAVEs may be used in the high-TFE, and the cure site monomer is preferably CF₂═CFO(CF₂)₅CN. Suitable such perfluoropolymers are commercially available from Daikin Industries, Ltd. and are described in U.S. Pat. Nos. 6,518,366, 6,878,778 and U.S. Published Patent Application No. 2008-0287627, which are each incorporated herein in relevant part with respect to the high-TFE perfluoropolymers described therein.

If the perfluoropolymer is in a blended composition, the second perfluoropolymer used herein may be the same or different than that noted above for use as the high-TFE first perfluoropolymer, but need not have a high content of TFE. Preferably the second perfluoropolymer is one in which fluoroplastic material has been blended into the polymer and exists within the polymer in particulate form, which particulate form is preferably a micro- or nano-particulate form, however, particle size may vary depending on the manufacturing process used. The particles may be provided in a variety of forms and using a variety of techniques. Fluoroplastics such as TFE, and melt-processible co-polymers thereof (FEP and PFA type polymers), core-shell polymers in a variety of sizes (microparticles, nanoparticles and the like) may be incorporated into the material by mechanical means or chemical processing and/or polymerization. Preferably, the fluoroparticles are micro-or nano-particle sized and/or are incorporated into the second perfluoropolymer using melt blending or latex polymerization techniques. Melt blending techniques may be employed, such as those described in U.S. Pat. Nos. 4,713,418 and 7,476,711 (each of which is incorporated herein by reference with respect to such melt-process technology). Latex polymerization techniques are also useful and are most preferred for incorporating fluoroplastics into the second perfluoropolymer herein. A suitable process and resulting perfluoropolymer incorporating core-shell and other particles having cure sites incorporated into the particles as well is described in U.S. Pat. No. 7,019,083, also incorporated herein by reference with respect to such perfluoropolymers having fluoroplastic particles and methods for making the same and may have the monomer contents and combinations of materials described therein. Suitable such polymers are commercially available from Dyneon (3M Corporation) of St. Paul, Minn.

Examples of other perfluoropolymers and resulting elastomers formed therefrom using cure site monomers such as those noted above may be also be found in WO 00/29479 A1, incorporated herein in relevant part with respect to such perfluoroelastomers, their content and methods of making the same. Reference is also made to U.S. Pat. Nos. 6,518,366, 6,878,778 and U.S. Published Patent Application No. 2008-0287627 as well as U.S. Pat. No. 7,019,083.

Perfluoropolymers for use in the compositions for bonding using the bonding agents described herein may be synthesized using any known or to be developed polymerization technique for forming fluorine-containing elastomers using polymerization, including, for example, emulsion polymerization, latex polymerization, chain initiated polymerization, batch polymerization and others. Preferably, the polymerization is undertaken so that reactive cure sites are located either on either or both terminal ends of the polymer backbone and/or are depending from the main polymer backbone.

One possible method of making the polymers includes radical polymerization using an initiator such as those known in the art for polymerization of fluorine-containing elastomers (organic or inorganic peroxide and azo compounds). Typical initiators are persulfates, percarbonates, peresters and the like, with preferred initiators being include salts of persulfuric acid, oxidizing carbonates and esters, and ammonium persulfate, with the most preferred being ammonium persulfate (APS). These initiators may be used alone or with reducing agents, such as sulfites and sulfite salts.

A wide variety of emulsifiers for emulsion polymerization can be used, but preferred are salts of carboxylic acid having a fluorocarbon chain or a fluoropolyether chain, to suppress chain transfer reactions to the emulsifier molecules that occur during polymerization. The amount of emulsifier is generally used in amounts of about 0.05 to 2 weight percent, and preferably 0.2 to 1.5 weight percent, based on the added water. It is noted that a special arrangements should be used to avoid an ignition source, such as sparks, near the polymerization equipment. See, G. H. Kalb, Advanced Chemistry Series, 129, 12 (1973).

Polymerization pressure may vary, and can generally be in the range 0.5 to 7 MPa. The higher the polymerization pressure is, the higher the polymerization rate will be. Accordingly if productivity enhancement is desired, the polymerization pressure is preferably at least 0.7 MPa. Latex polymerization techniques are also described in U.S. Pat. No. 7,019,083, which is also incorporated herein by reference for manufacturing techniques described therein.

Standard polymerization procedures known in the art may be used. If a nitrogen-containing group, such as nitrile or cyano, a carboxyl group, or an alkoxycarbonyl group is to be used in the curable perfluoropolymers herein, it may be included in the polymer by copolymerizing an additional monomer having the crosslinking site containing that group. The cure-site monomer may be added and copolymerized when preparing the fluorine-containing elastomer. A further method for providing such a group to the polymer is by subjecting a polymerization product to an acid treatment to convert a group such as a metallic salt or ammonium salt of a carboxylic acid contained in the polymerization product to a carboxyl group. Examples of a suitable acid treatment method are washing with hydrochloric acid, sulfuric acid, nitric acid or fuming sulfuric acid or by decreasing a pH value of a mixture system after the polymerization reaction to 3 or less by using the above-mentioned acids. Another method for introducing a carboxyl group is by oxidizing a crosslinkable polymer having iodine and bromine, with fuming nitric acid.

Uncured perfluoropolymers are commercially available, including perfluoropolymers sold by Dyneon (3M Corporation), Daiel-Perfluor® and other similar polymers, available from Daikin Industries, Ltd. of Osaka, Japan. Other suitable materials are available also from Solvay Solexis in Italy, Federal State Unitary Enterprise S. V. Lebedev Institute of Synthetic Rubber of Petersburg, Russia, Asahi Glass, Japan, and W. L. Gore.

In their uncured or curable state, the fluoroelastomer compositions useful with bonding agents of the invention preferably include at least one curing agent that is capable of undergoing a crosslinking reaction with one of the functional groups of the at least one cure site monomers present on the fluoropolymer(s). Any curing agent or combination of curing agents, co-curing agents and/or cure accelerators may be used. As examples, one may use functional group that reacts with a peroxide curing agent and/or co-curing agent in a peroxide cure system, or a curing agent that reacts with a cyano functional group in a cyano-functional cure system, depending on the end product and physical characteristics desired of the fluoroelastomer compositions herein. Regardless of the cure system or combination of systems employed, the fluoropolymer may contain at least one cure site monomer, although the presence of about 2 to about 20 cure site monomers (the same or different) may be used if desired.

When using a peroxide cure system, suitable curable perfluoropolymers include polymers of TFE, PAVES such as those described in U.S. Pat. No. 5,001,278 (incorporated herein in relevant part by reference), and cure site monomers having a fluorinated structure with a peroxide-curable functional group, such as, for example, halogenated alkyl and other derivatives, and partially- or fully-halogenated hydrocarbon groups.

If a cyano-curable system is used, suitable fluoropolymers include these as described in WO 00/08076, incorporated herein by reference, or other similar structures. Examples include tetrafluoroethylene, perfluoromethylvinyl ether, and primary and secondary cyano curable curesite monomers such as CF₂═CFO(CF₂)₃OCF(CF₃)CN, and/or CF₂═CFOCF₂CF(CF₃)O(CF₂)₂CN. Other suitable compounds may be those having a Mooney viscosity (measured at 100° C. on a TechPro® viscTECH TPD-1585 viscometer) of about 45 to about 95, and preferably of about 45 to about 65. Such materials may also be used in combination with other curing agents and/or with cure accelerators.

Any curing agent (curative) or combination of curing agents may be used. Curing agents for peroxide-based cure systems may be any peroxide curing agents and/or co-curing agents known to be developed in the art, such as organic and dialkyl peroxides or other peroxides capable of generating radicals by heating and engaging in a cross-linking reaction with the functional group(s) of a curesite monomer on the fluoropolymer chain. Exemplary dialkylperoxides include di-tertbutyl-peroxide, 2,5-dimethyl-2,5-di(tertbutylperoxy)hexane; dicumyl peroxide; dibenzoyl peroxide; ditertbutyl perbenzoate; and di-[1,3-dimethyl-3-(tertbutylperoxy)butyl]-carbonate. Other peroxidic systems are described, for example, in U.S. Pat. Nos. 4,530,971 and 5,153,272, incorporated in relevant part with respect to such curing agents by reference. Co-curing agents for such peroxide curing agents typically include isocyanurates and similar compounds that are polyunsaturated and work with the peroxide curing agent to provide a useful cure, such as, for example, triallyl cyanurate; triallyl isocyanurate; tri(methallyl)isocyanurate; tris(diallylamine)-s-triazine; triallyl phosphite; N,N-diallyl acrylamide; hexaallyl phosphoramide; N,N,N′,N′-tetraalkyl tetraphthalamide; N,N,N′,N′-tetraallyl malonamide; trivinyl isocyanurate; 2,4,6-trivinyl methyltrisiloxane; and tri(5-norbornene-2-methylene)cyanurate. The most preferred is and well known in the art is triallyl isocyanurate (TAIC) which is sold under the trade name DIAK®, e.g. DIAK® #7 and TAIC®.

For the cyano-based systems, suitable primary curing agents include those mentioned herein as well as monoamidines and monoamidoximes as described as U.S. Patent Publication No. US-2004-0214956-A1, the disclosure of which is incorporated herein by reference in relevant part.

The amidine-based and amidoxime-based materials include monoamidines and monoamidoximes of the following formula (I) described further below. Preferred monoamidines and monoamidoximes may be represented by formula (I):

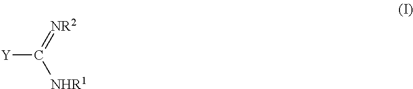

wherein Y may be a substituted alkyl, alkoxy, aryl, aralkyl or aralkoxy group or an unsubstituted or substituted fully or partially halogenated alkyl, alkoxy, aryl, aralkyl or aralkoxy group having about 1 to about 22 carbon atoms. Y may also be a perfluoroalkyl, perfluoroalkoxy, perfluoroaryl, perfluoroaralkyl or perfluoroaralkoxy group of about 1 to about 22 carbon atoms or a perfluoroalkyl or perfluoroalkoxy group of about 1 to 12 carbon atoms, or about 1 to about 9 carbon atoms; and R¹ may be hydrogen or substituted or unsubstituted lower alkyl or alkoxy groups of about 1 to about 6 carbon atoms, oxygen (such that NHR¹ is a NOH group) or an amino group. R² may be independent from any of the groups listed above for R¹ or a hydroxyl. Substituted groups for Y, R¹ or R² include, without limitation, halogenated alkyl, perhalogenated alkyl, halogenated alkoxy, perhalogenated alkoxy, thio, amine, imine, amide, imide, halogen, carboxyl, sulfonyl, hydroxyl, and the like. If R¹ and R² are both selected as oxygen and hydroxyl, such that there are two NOH groups on the compound (a dioxime can be used), and in that case, formula (I) can be found modified to accommodate a dioxime formula in which the carbon atom and the Y group together form an intervening aromatic ring and in which the NOH groups are located ortho-, para- or meta- to one another on the ring, such as with p-benzoquinonedioxime.

In formula (I), R² may be hydroxyl, hydrogen or substituted or unsubstituted alkyl or alkoxy groups of about 1 to about 6 carbon atoms, more preferably hydroxyl or hydrogen. R¹ may be hydrogen, oxygen, amino or substituted or unsubstituted lower alkyl of about 1 to about 6 carbon atoms while R² is hydrogen or hydroxyl. R¹ and R² may both be hydrogen. Y may be a perfluoroalkyl, perfluoroalkoxy, substituted or unsubstituted aryl groups and substituted or unsubstituted halogenated aryl groups having the chain lengths as noted above, particularly preferred are when R¹ and R² are both hydrogen and Y is CF₃(CF₂)₂—i.e. when the compound is heptafluorobutyrlamidine or a similar amidoxime compound.

Exemplary monoamidine-based and monoamidoxime-based curing agents include perfluoroalkylamidines, arylamidines, perfluoroalkylamidoximes, arylamidoximes and perfluoroalkylamidrazones. Other examples include perfluorooctanamidine, heptafluorobutyrylamidine, trifluoromethylbenzamidoxime, and trifluoromethoxybenzamidoxime, with heptafluorobutyrlamidine being most preferred.

Other curing agents can include bisphenyl-based curing agents and their derivatives, such as bisaminophenol, tetraphenyltin, triazine, peroxide-based curing systems (e.g. organic peroxide such as dialkyl peroxides), or combinations thereof. Other suitable curing agents include oganometallic compounds and the hydroxides, especially organotin compounds, including ally-, propargyl-, triphenyl- and allenyl tin, curing agents containing amino groups such as diamines and diamine carbamates, such as N,N′-dicinnamylidene-1,6-hexanediamine, trimethylenediamine, cinnamylidene, trimethylenediamine, cinnamylidene ethylenediamine, and cinnamylidene hexamethylenediamine, hexamethylenediamine carbamate, bis(4-aminocyclohexly)methane carbamate, 1,3-diaminopropane monocarbamate, ethylenediamine carbamate, trimethylenediamine carbamate, bisaminothiophenols, bisamidoximes, and bisamidrazones.

In a high-TFE content perfluoropolymer embodiment and/or blend thereof for use with the bonding agents herein, the preferred curatives for such high-temperature blend compositions of the present invention are one of various cure sites described herein that are capable of curing (i.e., capable of crosslinking) or otherwise undergoing a curing reaction with the cure sites or functional groups of the cure site monomer(s) or cure site in the various uncured perfluoropolymers in the compositions to form crosslinks as noted hereinabove, and especially preferred are crosslinking or curing agents are those that form crosslinks that have oxazole, thiazole, imidazole, or a triazine rings. Such compounds as well as other curatives including amidoximes, tetraamines and amidrazones may be used for cross-linking in the present invention. Of these, imidazoles are preferred in that crosslinked article providing excellent mechanical strength, heat resistance, chemical resistance, cold resistance is achievable, particularly a cured article which is balanced and excellent with respect to heat resistance and cold resistance.

For nitrogen-containing cure sites, other curatives such as bisphenyl-based curatives and derivatives thereof, including bisaminophenol and its salts (such as bisaminophenol AF), bisaminothiphenols, parabenzoquinone dioxime (PBQD) and tetraphenyltin may be used. Examples of suitable curatives may be found, for example, in U.S. Pat. Nos. 7,521,510 B2, 7,247,749 B2 and 7,514,506 B2, each of which is incorporated herein in relevant part with respect to the listing of various curatives for cyano-group containing perfluoropolymers. In addition, the perfluoropolymers may be cured using radiation-curing technology.

Most preferred are cyano-group containing cure sites cured with curatives that are aromatic amines having at least two crosslinkable groups as in formulas (I) and (II) below, or a combination thereof, which form benzoimidazole cross-linking structures upon cure. These curatives are known in the art and discussed in relevant part and with specific examples in U.S. Pat. Nos. 6,878,778 and 6,855,774, which are incorporated herein in their entirety.

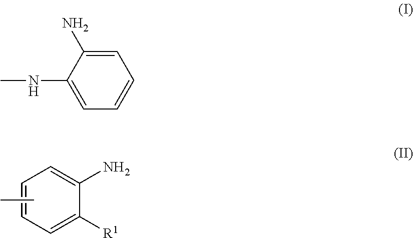

wherein R¹ is the same or different in each group according to formula (II) and may be NH₂, NHR², OH, SH or a monovalent organic group or other organic group such as alkyl, alkoxy, aryl, aryloxy, aralkyl and aralkyloxy of from about 1 to about 10 carbon atoms, wherein the non-aryl type groups may be branched or straight chain and substituted or unsubstituted and R² may be —NH₂, —OH, —SH or a monovalent or other organic group such as an aliphatic hydrocarbon group, a phenyl group and a benzyl group, or alkyl, alkoxy, aryl, aryloxy, aralkyl and aralkyloxy groups, wherein each group is from about 1 to about 10 carbon atoms, wherein the non-aryl type groups may be branched or straight chain and substituted or unsubstituted. Preferred monovalent or other organic groups, such as alkyl and alkoxy (or perfluorinated versions thereof) are from 1 to 6 carbon atoms, and preferred aryl type groups are phenyl and benzyl groups. Examples thereof include —CF₃, —C₂F₅, —CH₂F, —CH₂CF₃ or —CH₂C₂F₅, a phenyl group, a benzyl group; or a phenyl or benzyl group wherein 1 to about 5 of the hydrogen atoms are substituted by fluorine atoms such as —C₆F₅, —CH₂C₆CF₅, wherein groups may be further substituted, including with —CF₃ or other lower perfluoroalkyl groups, or, phenyl or benzyl groups in which 1 to 5 hydrogen atoms are substituted by CF₃ such as for example C₆H₅₋ₙ(CF₃)ₙ, —CH₂C₆H₅₋ₙ(CF₃)ₙ (wherein n is from 1 to about 5). Hydrogen atoms may be further substituted with phenyl or benzyl groups. However, a phenyl group and CH₃ are preferred as providing superior heat resistance, good cross-linking reactivity and relatively easy synthesis.

A structure having formula (I) or (II) incorporated in an organic amine should include at least two such groups of formula (I) or (II) such that at least two cross-linking reactive groups are provided.

Also useful herein are curatives having formulas (III), (IV) and (V) shown below.

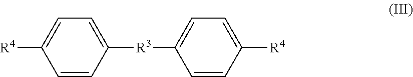

wherein R³ is preferably SO, O or CO or an organic or alkylene type group, such as an alkyl, alkoxy, aryl, aralkyl or aralkoxy group of from one to six carbon atoms or perfluorinated versions of such groups, having from about one to about 10 carbon atoms, and being branched or straight chain, saturated or unsaturated, and branched or straight chain (with respect to the non-aryl type groups) or a single bond. R⁴ is preferably a reactive side group such as those set forth below:

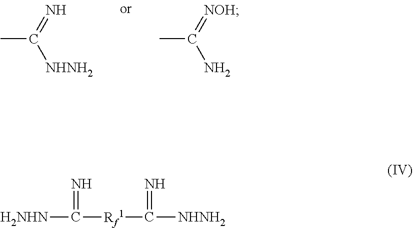

wherein R_{f}¹ is a perfluoroalkyl or perfluoroalkoxy group of from about 1 to about 10 carbon atoms that may be a straight or branched chain group and/or saturated or unsaturated and/or substituted or unsubstituted; and

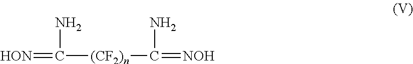

wherein n is an integer of about 1 to about 10.

Combinations of all of the curatives herein are within the scope of the invention so long as there are companion functional curesite monomer groups with which the curatives may react on the curable polymers in the compositions, and each of such compositions may be bonded using the bonding agents herein. With respect to heat resistance, oxazole-, imidazole-, thiazole- and triazine-ring forming crosslinking agents are preferred and can include the formula compounds listed below and discussed further below with respect to Formulae (I), (II), (III), (IV) and (V), specifically, formula (II) wherein R¹ is the same or different and each is —NH₂, —NHR², —OH or —SH, wherein R² is a monovalent organic group, preferably not hydrogen; formula (III) wherein R³ is —SO₂—, —O—, —CO—, and alkylene group of 1 to about 6 carbon atoms, a perfluoroalkylene group of 1 to about 10 carbon atoms or a single bond and R⁴ is as noted below; formula (IV) wherein R_{f}¹ is a perfluoroalkylene group of 1 to about 10 carbon atoms, and formula (V) wherein n is an integer of 1 to about 10. Of such compounds, those of formula (II) as noted herein are preferred for heat resistance, which is enhanced due to stabilization of the aromatic rings after crosslinking. With respect to R¹ in the formula (II), it is preferred also to use —NHR² as R¹, since an N—R² bond (wherein R² is a monovalent organic group and not hydrogen) is higher in oxidation resistance than an N—H bond.

Compounds having at least two groups as in formula (II) are preferred and having 2 to 3 crosslinkable reactive groups thereon, more preferably having 2 crosslinkable groups.

Exemplary curatives based on the above preferred formulae include at least two functional groups, such as the following structures formula (VI), (VII) or (VIII):

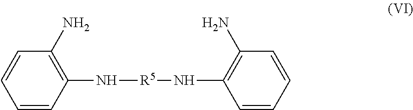

wherein R⁵ represents a saturated or unsaturated, branched or straight chain, substituted or unsubstituted group such as alkyl, alkoxy, aryl, SO, O, CO, or similar groups which are perfluorinated with respect to the carbon atoms and which is preferably about 1 to about 10 carbon atoms;

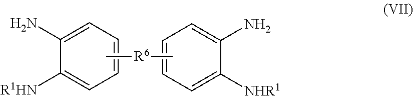

wherein R¹ is as defined elsewhere herein and R⁶ may be O, SO₂, CO or an organic group which may be perfluorinated, such as alkyl, alkoxy, aryl, aryloxy, aralkyl and aralkyloxy of from about 1 to about 10 carbon atoms, wherein the non-aryl type groups may be branched or straight chain and substituted or unsubstituted, or a single or alkylene bond.

From the view of easy synthesis, preferred crosslinking agents are compounds having two crosslinkable reactive groups as represented by formula (II) are shown below in formula (VIII).

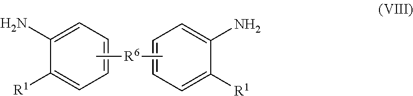

wherein R¹ is as above and R⁶ is —SO₂, —O—, —CO—, an alkylene group of 1 to about 6 carbon atoms, a perfluoroalkylene group of 1 to about 10 carbon atoms, a single bond or a group as shown in Formula (IX):

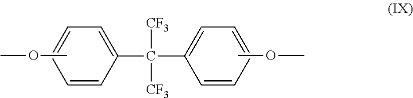

wherein this formula provides an easier the synthesis. Preferred examples of alkylene groups of from 1 to about 6 carbon atoms are methylene, ethylene, propylene, butylene, pentylene, hexylene and the like. Examples of perfluoroalkylene groups of 1 to about 10 carbon atoms are

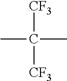

and the like. These compounds are known as examples of bisaminophenyl compounds. Preferred compounds according to this structure include those of formula (X):

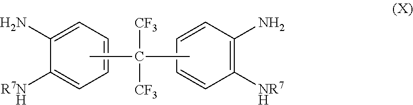

wherein R⁷ is the same or different in each instance and each R⁷ is hydrogen, an alkyl group of 1 to about 10 carbon atoms; a partially fluorinated or perfluorinated alkyl group of 1 to 10 carbon atoms; a phenyl group; a benzyl group; or a phenyl or benzyl group in which 1 to about 5 hydrogen atoms have been replaced by fluorine or a lower alkyl or perfluoroalkyl group such as CF₃.

Non-limited examples of curatives include 2,2-bis(2,4-diaminophenylhexafluoropropane, 2,2-bis[3-amino-4-(N-methylamino)phenyl]hexafluoropropane, 2,2-bis[3-amino-4-(N-ethylamino)phenyl]hexafluoropropane, 2,2-bis[3-amino-4-(N-propylamino)phenyl]hexafluoropropane, 2,2-bis[3-amino-4-(N-phenylamino)phenyl]hexafluoropropane, 2,2-bis[3-amino-4-(N-perfluorophenylamino)phenyl]hexafluoropropane, 2,2-bis[3-amino-4(N-benzylamino)phenyl]hexafluoropropane, and similar compounds. Of these, for preferred excellent heat resistance properties, 2,2-bis[3-amino-4(N-methylamino)phenyl]hexafluoropropane, 2,2-bis[3-amino-4-(N-ethylamino)phenyl]hexafluoropropane, 2,2-bis[3-amino-4-(N-propylamino)phenyl]hexafluoropropane and 2,2-bis[3-amino-4-(N-phenylamino)phenyl]hexafluoropropane are preferred. Also preferred for heat resistant properties is tetra-amines such as 4,4′-[2,2,2-Trifluoro-1-(trifluoromethyl) ethylidene]bis[N1-phenyl-1,2-benzenediamine] or 2,2-bis[3-amino-4-(N-phenylaminophenyl)]hexafluoropropane is preferred.

Other suitable curatives include oxazole-, imidazole-, thiazole-, and triazine-ring forming curatives, amidoxime and amidrazone crosslinking agents, and particularly bisaminophenols, bisaminothiophenols, bisamidines, bisamidoximes, bisamidrazones, monoamidines, monoamidoximes and monoamidrazones as known in the art or to be developed, examples of which are set forth, for example in U.S. Pat. Nos. 7,247,749 and 7,521,510, incorporated herein in relevant part by reference, including the curatives and co-curatives and accelerators therein. Imidazoles are useful in that they can contribute to good mechanical strength, heat resistance, chemical resistance, and low temperature capacity, as well as a good balance of crosslinking properties and high and low temperature properties. The bisamidoxime, bisamidrazone, bisaminophenol, bisaminothiophenol or bisdiaminophenyl curatives can react with nitrile or cyano groups, carboxyl groups, and/or alkoxycarbonyl groups in the perfluoropolymer to form a perfluoroelastomer preferred in some embodiments herein having an oxazole ring, a thiazole ring, an imidazole ring, or a triazine ring as crosslinks in the resulting cured articles formed from the compositions useful with the bonding agents herein.

In one embodiment herein, a curative compound can be used including at least two chemical groups with cross-linking reactive groups as in Formula (I) or (II) in order to increase heat resistance and to stabilize an aromatic ring system. For groups such as in (I) or (II), having two to three such groups, it is preferred to have at least two in each group (I) or (II), as having a lesser number of groups may not provide adequate cross-linking.

Such compositions preferably are blends having the first curable perfluoropolymer and the second curable perfluoropolymer in a ratio of about 25 to about 75 mole percent to about 75 to about 25 mole percent, preferably about 40 to about 60 mole percent to about 60 to about 40 mole percent, and most preferably about 50 to about 50.

Each of the at least one cure site monomers in each of the curable perfluoropolymers is preferably present in an amount of about 0.01 to about 10 mole percent respectively and individually in each of the first curable perfluoropolymer and the second curable perfluoropolymer. The at least one curative is preferably present in an amount of about 0.01 to about 5 parts by weight per 100 parts by weight of the perfluoropolymers in the composition, and more preferably about 0.01 to about 2 parts by weight per 100 parts by weight of the perfluoropolymers in the composition.

The at one cure site in the at least one cure site monomer in either or both of the first and second curable perfluoropolymers is preferably a nitrogen-containing cure site. The at least one cure site in the at least one cure site monomer in the first curable perfluoropolymer may be selected from the group consisting of cyano, carboxyl, carbonyl, alkoxycarbonyl, and combinations thereof, and most preferably is a cyano group.

The at least one curative may also be one of the following suitable curatives within the scope of the invention: fluorinated imidoylamidines; bisaminophenols; bisamidines; bisamidoximes; bisamidrazones; monoamidines; monoamidoximes; monoamidrazones; biasminothiophenols; bisdiaminophenyls; tetra-amines and aromatic amines having at least two crosslinkable groups represented by the formula (II):

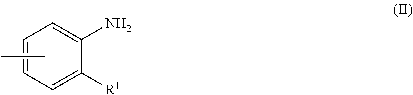

wherein R¹ are the same or different and each is —NH₂, —NHR², —OH or —SH; R is a monovalent organic group;

compounds represented by the formula (III):

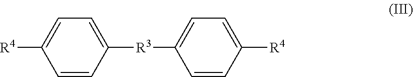

wherein R³ is —SO₂—, —O—, —CO—, an alkylene group having 1 to 6 carbon atoms, a perfluoroalkylene group having 1 to 10 carbon atoms or a single bond and R⁴ is

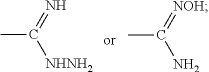

compounds represented by Formula (IV):

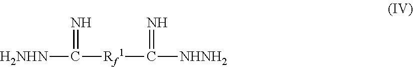

wherein R_{f}¹ is a perfluoroalkylene group having 1 to 10 carbon atoms; compounds represented by the formula (V):

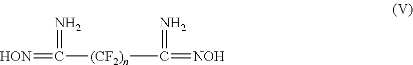

in which n is an integer of 1 to 10; and combinations thereof, wherein the at least curative is capable of reacting with the least one cure site in the at least one first perfluoropolymer and the at least one cure site in the second perfluoropolymer to crosslink the at least one perfluoropolymer and the at least one second perfluoropolymer in the composition.

The at least one curative may further be an aromatic amine having at least two crosslinkable groups represented by the formula (II), wherein R¹ is —NHR²; fluorinated imidoylamidines; bisaminophenols; and combinations thereof.

In one embodiment, the curable fluorine-containing elastomer composition useful with the bonding agents herein includes the at least one curative as a compound which is preferably a tetra-amine compound within the scope of those compounds noted above. Such compounds may be used alone or in combination. Most preferred compounds for use herein as curatives are those in accordance with formula (II) wherein R¹ is —NHR² and R² is an aryl group. Such compound is also known as is 4,4′[2,2,2-Trifluoro-1-(trifluoromethyl)ethylidene[bis[N1-phenyl-1,2-benzenediamine] (“Nph-AF”).

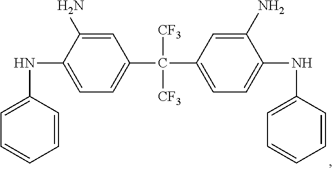

Another preferred curative includes perfluoroimidoylamidines such as those found in U.S. Patent Publication No. 2008-0035883 A1, incorporated by reference herein with respect to the following compound and similar compounds. One preferred compound, also described as DPIA-65 is shown hereinbelow.

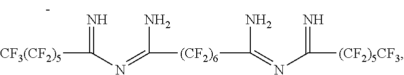

Other preferred compounds are bisaminophenol, bisaminophenol AF, and combinations thereof.

In yet further embodiments, the composition is preferably a perfluoroelastomer composition and the at least one curative includes use of Nph-AF

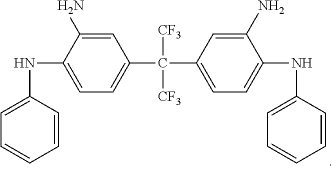

This compound may be used alone or with another curative(s), such as in combination with bisaminophenol or bisaminophenol AF and/or in combination with or as an alternative thereto, wherein the at least one curative may further comprise the DPIA-65:

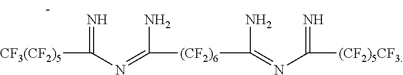

The bonding agent is preferably used with a curable perfluoroelastomer composition comprising a first curable perfluoropolymer comprising tetrafluoroethylene, a first perfluoroalkylvinyl ether and at least one first cure site monomer having at least one cure site, wherein the tetrafluoroethylene is present in the first curable perfluoropolymer in an amount of at least about 50 mole percent; a second curable perfluoropolymer comprising tetrafluoroethylene, a second perfluoroalkylvinyl ether and at least one second cure site monomer having at least one cure site, wherein the second curable perfluoropolymer comprises fluoroplastic particles therein; and at least one curative the at least one curative is selected from the group consisting of: at least one curative the at least one curative is selected from the group consisting of:

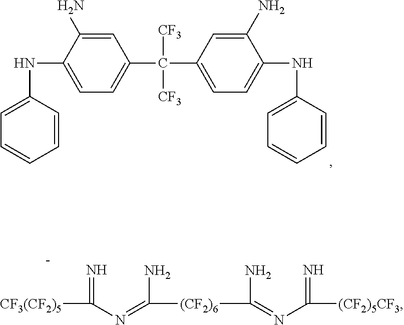

bisaminophenol, bisaminophenol AF, and combinations thereof; wherein at least one of the cure site monomer in the first curable perfluoropolymer and the cure site monomer in the second curable perfluoropolymer is CF₂═CFO(CF₂)₅CN, and wherein the second curable fluoropolymer comprises fluoroplastic particles as a result of blending during latex polymerization, the fluoroplastic particles comprising a nitrogen-containing cure site monomer.

These are intended as examples only and the bonding agents herein may be used with a wide variety of fluoro- and perfluoroelastomer compositions.

Any curing agent(s) may be used alone, in combination, or with secondary curing agents. Thus, the curing system does not require, but may also optionally include, a variety of secondary curing agents, such as bisphenyl-based curing agents and their derivatives, tetrapheyltin, triazine, peroxide-based curing systems (e.g., organic peroxides such as dialkyl peroxides) if not used as a primary agent or if used in a combination or peroxides, or combinations of these systems. Other suitable secondary curing agents include oganometallic compounds and the hydroxides thereof; especially organotin compounds, including ally-, propargyl-, triphenyl- and allenyl tin, curing agents containing amino groups such as diamines and diamines carbamates, such as N,N′dicinnamylidene-1,6-hexanediamine, trimethylenediamine, cinnamylidene, trimethylenediamine, cinnamylidene ethylenediamine, and cinnamylidene hexamethylenediamine, hexamethylenediamine carbamate, bis(4-aminocyclohexly)methane carbamate, 1,3-diaminopropane monocarbamate, ethylenediamine carbamate, trimethylenediamine carbamate, and bisaminothiophenols.

At least one of a curing agent, co-curing agent and/or a cure accelerator may also be included depending on the cure system adopted. The composition may also include least two curable fluoropolymers or perfluoropolymers, such as, for example, in a fluoropolymeric or perfluoropolymeric blend.

Examples of optional fillers which may be used in the FKM compositions herein including, for example, without limitation, fluoropolymer powders, fluoropolymer micropowders, core-shell fluorpolymer fillers, fluoropolymer nanopowders, cross-linkable fluoroplastic fillers, carbon black, fluorographite, silica, silicates, glass fiber, glass spheres, fiberglass, calcium sulfate, asbestos, boron fibers, ceramic fibers, aluminum hydroxide, barium sulfate, calcium carbonate, magnesium carbonate, alumina, aluminum nitride, borax, perlite, zinc terephthalate, silicon carbide platelets, silicon carbide whiskers, wollastonite, calcium terephthalate, fullerene tubes, Hectorite, talc, mica, carbon nanotubes. Such fillers may be present in the overall composition in amounts of up to about 50 parts per hundred per 100 parts base fluoropolymer, preferably up to about 20 parts per hundred, wherein the 100 parts base fluoropolymer would include all such base fluoropolymer(s) in the composition.

In FFKM compositions, for use, for example in semiconductor applications, preferred optional filler(s) may optionally be fluoropolymer powders, fluoropolymer micropowders, core-shell fluorpolymer fillers, fluoropolymer nanopowders, cross-linkable fluoroplastic fillers, carbon black, fluorographite, silica, silicates, barium sulfate, calcium carbonate, magnesium carbonate, alumina, aluminum nitride, and carbon nanotubes. Silica, carbon black (such as a high purity thermal carbon black), fluoropolymer micropowders, nanopowders and cross-linkable fluoroplastics being most preferred. Preferably no heavy metal additives are provided in compositions herein used in semiconductor processing applications.

The above-discussed fluoroelastomeric composition may contain any or all of the various components discussed above in varied proportions, ratios, and permutations. Individuals of skill in the art will recognize such ingredients and relative ratios may be altered and varied depending on the desired characteristics of the end product, which in turn is informed by the application into which the bonded component is to be used.

Preferably, based on 100 parts of a base fluoropolymer(s), curing agent(s) are present in the amount necessary to provide adequate cure for the given functional group(s), for example, in an amount of about 0.1 to about 5 parts per 100 parts base fluoropolymer(s), preferably about 0.2 to about 3 parts per hundred or about 2 to about 4 parts per hundred curing agent(s). If the curing agent is part of a peroxide curing system co-curing agents, such as TAIC, are preferably added in amounts of about 1 parts to about 10 parts per hundred based on 100 parts base fluoropolymers, and about 1 to about 5 parts per hundred based on 100 parts of the base fluoropolymer(s) herein. Optionally, as noted elsewhere herein, accelerators or co-curing agents can be used in preferred amounts, for example, of 0 to about 6 parts per hundred based on 100 parts by weight of the base fluoropolymer(s).

Such cured fluoroelastomer, and preferably perfluoroelastomer, compositions formed from curable fluoroelastomer, and preferably perfluoroelastomeric, compositions having curable fluoro- and per-fluoropolymers as noted herein may be cured and shaped so as to form a molded article(s). Generally, the molded articles will be formed as sealing members such as O-rings, seals, gaskets, inserts and the like, but other shapes and uses known or to be developed in the art are contemplated herein.

The molded article may be bonded to a surface by way of the bonding compositions herein for forming, for example, bonded seals. Such bonded seals may be used, for example for forming pre-bonded doors, gates, and slit valve doors for use, e.g., in semiconductor processing. The surfaces to which such molded articles, such as seals may be bonded include polymeric surfaces as well as metal and metal alloy surfaces. In one embodiment, the invention includes a gate or slit valve door formed of, e.g., stainless steel or aluminum, to which an O-ring seal conforming to a recess in the door configured for receiving the seal. The bonding may occur through use of the bonding composition herein which is applied to the surface of the seal and/or the substrate surface.

The bonding composition is preferably capable of bonding a fluoroelastomer composition, and preferably a perfluoroelastomer composition, to a substrate. Substrates which are contemplated as within the scope of the invention include ceramics, metals, metal alloys, semiconductors, polymers, and combinations thereof The bonding composition may also be capable of successfully bonding a fluoroelastomer composition to alumina, sapphire, boron, yttria, silicon, germanium, arsenic, antimony, tellurium, polonium, anodized aluminum, aluminum, stainless steel, polytetrafluoroethylene, and combinations thereof. The fluoroelastomers may be bonded using the bonding agent to other fluoroelastomers or perfluoroelastomers.

Such substrates may include materials that are substrates for various structures and/or laminates, some of which may be used inside a semiconductor processing chamber, or may be substrates actually used to form parts of processing equipment, for example, in semiconductor processing equipment (chamber walls, processing doors, gates, etc.). Substrates may include materials such as, for example, ceramic, metals, metal alloys, semiconductors, and polymers. Preferred substrates in semiconductor processing and other areas include ceramics such as alumina, sapphire, and other similar materials, semiconducting metals and metalloids, such as boron, silicon, germanium, arsenic, antimony, tellurium, polonium, and metallic surfaces used in such applications for processing chambers, doors and the like such as anodized aluminum, aluminum and stainless steel, and other materials used in such equipment such as polytetrafluoroethylene (PTFE) seal, o-ring and gasket shielding materials.

For other end applications, it is possible to use the bonding compositions herein to bond FKMs or FFKMs to other surfaces such as metals, including, for example, beryllium, copper, silver, aluminum, chromium, titanium, nickel, zinc and/or metal alloys or other metal mixtures, such as, for example, titanium alloys and copper alloys, beryllium-copper alloys, nickel-silver alloys, nickel-titanium alloys, chromium alloys, brass, and stainless steel. Titanium alloys and nickel alloys, such as the austenitic nickel-based superalloys sold under the tradename INCONEL® by Special Metal Corporation, New Hartford, N.Y., United States of America may be suitable as well. Other suitable polymeric substrates include PTFE, polyaryl ether ketones (PAEK) polymers, such as, for example, polyetheretherketone (PEEK), polyetherketoneketone (PEKK), polyetherketone etherketone ketone (PEKEKK), PEEK blended with thermoplastic polyimide (PEEK+TP-PI), and polyetherketone (PEK).

The bonding composition herein is also suitable for use as a primer composition for use in other adhesive applications and/or with other adhesive agents and/or for or as an adhesive layer. Thus is may have end applications in coating and laminate applications as well or for use in adhering various materials to a substrate. In the polymerization of FFKM, these emulsifiers free of PFOA are most preferred.

The bonding agents may be applied to the substrates using a variety of techniques, spray coating, brush coating, dipping roll coating or any suitable application technique, with brushing and spray coating being preferred. In bonding, the fluoroelastomer composition is bonded as a result of the bonding agent composition so as to form a bond between a portion of the curable fluoropolymer to a portion of the substrate, wherein some or all of the surfaces may be bonded. As the fluoropolymer cures, to form a fluoroelastomer, the surfaces bond during the molding or other curing process and/or upon application of heat and pressure. Typical temperatures for curing/bonding for FKMs and FFKMs are in the range, for example, of about 100° C. to about 180° C., and preferably about 149° C. to about 154° C., with curing/bonding times of about 5 to about 35 minutes, preferably about 8 to about 20 minutes. However, one skilled in the art would understand from this disclosure that the curing times and temperatures will vary depending on the initial fluoroelastomer and crosslinking system chosen.

Pressure to be applied may be from various sources, such as a hot press mold and can range from about 200 psi to 3000 psi, depending again on the resulting structure to be formed and the materials being used therein.

The invention includes methods of bonding the fluoroelastomer composition to the surface of the substrate by contacting a curable FKM or FFKM composition (as described herein) to the substrate either fully along or partly along the surface and curing it via any curing means known or developed in the art. Most preferably, an FKM or FFKM composition is prepared by blending on a typical FKM or FFKM mixer or blending apparatus, and combining any additive, curing agents and/or additional co-curatives, cure accelerators and any fillers as noted herein. The resulting combined uncured composition (or gum) is then preferably formed into a preform wherein, the preform may be formed by any means, including cutting, clicking, extruding, molding, etc. Once formed, the pre-form surface and/or the substrate to which it is to be bonded are coated with the bonding composition. The bonding agent may be put along the entire surfaces to be mated or only along part of those surfaces.

The pre-form and substrate are then subjected to the curing process so that the pre-form is at least partially cured (e.g., some crosslinking may have occurred, but not to the desired extent). Preferably, however, the preform is contacted to the surface of the substrate and cured in situ while the bonding agent is activated and the pre-form is molded into a shape within a bonded structure. For example, an extruded rope can be situated in a groove in a bonded gate door having the bonding agent thereon, and then the extruded rope with bonding agent and the substrate are subjected to curing while the pre-form is being molded into a seal in the groove (in situ). Preforms can be placed on the surface in either in a groove, hole, or other surface feature or directly on a flat, curved or pre-configured surface for molding. Preforms can be made into shapes for which such FKMs and FFKMs are typically used, including o-rings, gaskets, seals, coatings, laminates and the like. In the case of a gate door, for example, in semiconductor processing equipment, a perform extrudate may be shaped to fit within a prepared groove in the door surface and the molding process will enable the fluoroelastomer composition to bond to the surface in the groove by way of the bonding composition.

Other preforms include, for example, an extruded or shaped sheet of the elastomer compositions herein, which can be placed on a surface, and optionally between two surfaces in a sandwich-like configuration and then heat molded to form coated surfaces or laminated structures. Similarly two performs may be bonded together using the bonding agent and cured locally to form larger parts.

The perfluoropolymer composition cures and the bonding agent then at least partially bonds to the substrate due to application of heat and/or pressure to the pre-form and the surface of the substrate while elastomer cross-linking proceeds and the elastomer forms by at least partially curing. The bonds thus continue to form between the composition and the substrate. Additional curing can continue and/or appropriate post-curing depending on the elastomer and the cure cycle used until substantially complete and/or complete curing and bonding are achieved.

Curing may be by any method known or to be developed in the art including heat cure, cure by application of high energy, heat cure, press cure, steam cure, a pressure cure, an e-beam cure or cure by any combination of means, etc. Post-cure treatments may also be applied, if desired for complete cure. As noted above, temperatures such as about 100° C. to about 180° C., and preferably about 120° C. to about 160° C. may be used for varying times as noted with respect to the curing/bonding conditions above, and again, can be varied depending on the FKM or FFKM system chosen, the curing system chosen and the end application. Optional post-curing may be applied, and would preferably be used when sufficient curing and/or bonding does not occur in the primary bonding/curing cycle.

The curable FKM or FFKM composition, as noted above, is prepared by combining the composition components by blending, mixing and the like, as noted above. A substrate having a surface, such as the substrates described above is then provided. At least one or both of the curable composition in the form of a pre-form and/or the substrate is coated (either partially or completely) with the bonding composition described herein. The curable composition pre-form is heat molded on the surface of the substrate with the curable FKM or FFKM composition thus bonding to the surface of the substrate, so as to at least partially cure the FKM or FFKM composition to form a fluoroelastomer or perfluoroelastomer and to at least partially bond the FKM or FFKM composition as it cures to the surface of the substrate thereby forming a bonded structure having an at least partially cured fluoroelastomer or perfluoroelastomer at least partially bonded to the surface of the substrate, and in the case of laminated structures, bonded to a first and a second surface, wherein the two surfaces may be the same material or different materials. Curing and bonding can continue until an adequate level of crosslinking and bonding is achieved, and the structure is preferably substantially completely, or completely, crosslinked and bonded.

The resulting bonded structures have an FFKM or FKM elastomer bonded to the surface of the substrate (or to a surface on a first substrate and a second substrate) by way of the bonding composition herein. Bonded structures may be, for example, a structure selected from the group consisting of a laminated structure, a gate valve, a semiconductor chamber door, and a bonded slit valve.

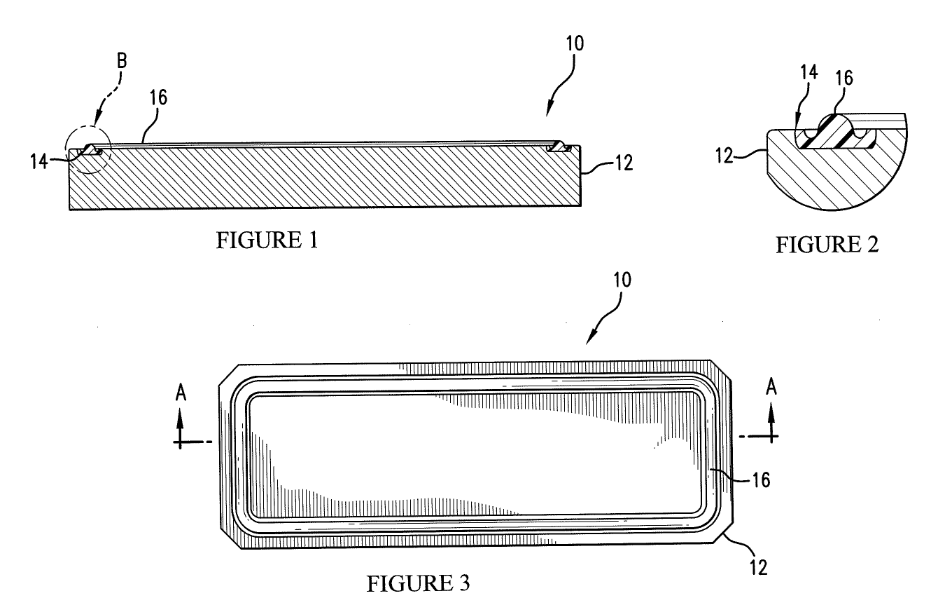

An example of a typical such substrate in the form of a slit valve can be seen in FIGS. 1 to 3. A slit valve door 10 has a metallic door 12 and a seal 16 that fits within a groove in the surface of the door 12. The seal is bonded to the surface 14 at the point shown in FIG. 2. In the invention herein, the seal 16 is formed of a curable perfluoropolymer or fluoropolymer composition as described herein and is bonded by way of the bonding composition at surface 14 to the door 12.

The invention will now be described with respect to the following non-limiting example(s).

### EXAMPLE 1

A bonding Control Example A was prepared using a commercial adhesive bonding agent available from Dyneon® (3M Corporation) as E-20524A. The compound used was a solvent-based compound with a methyl ethyl ketone base solvent (present in an amount of about 80-90 weight percent of the compound), about 5-10 weight percent epoxy hardening additive, along with about 5-10 weight percent additive polymers, and other additives: less than 1 weight percent 1-Propanamine, N-(1,3-Dimethylbutylidene)-3-(triethylsilyl)-DETA and/or MIBK/Ketimine. The adhesive bonding agent alone was applied in a thin coating to a metal substrate (aluminum) on one side. A similar coating was made using a bonding composition according to the invention (Example 1). The composition was prepared including 0.128 g of Pro-4302 from Cray Valley® (which is aluminum acrylate) and 2.5 g of the Dyneon adhesive bonding agent (i.e., the aluminum acrylate was added in an amount of 5.12 parts per 100 parts by weight of the Dyneon adhesive bonding agent). As noted above, the Dyneon adhesive bonding agent used in this Example includes MEK solvent in the bonding agent. A total of 2.5 g of the Dyneon bonding agent from Control Example A was used. Each of the bonding compositions, the Control Example A and the inventive Example 1 was bonded to an aluminum substrate by direct molding and tested.

Both the Control Example A and the inventive Example 1 were used on the same perfluoroelastomer composition. The composition was a blend of two perfluoroelastomers developed by the applicants herein for high-temperature and plasma-resistant processing.

The perfluoroelastomer composition included two curable perfluoropolymers. The first perfluoropolymer was a fluoroplastic-containing curable perfluoropolymer, Dyneon® PFE 133 TBX available from Dyneon, LLC, (3M Corporation) Minnesota, which is made without PFOA. Such polymer includes a cyano-functionalized PFA perfluoroplastic in an amount of about 20% within a curable perfluoropolymer matrix including a perfluoropolymer including TFE, PAVE and a cyano-containing cure site monomer.

The second perfluoropolymer was a curable perfluoropolymer from Daikin Industries, Ltd. available as GA-500PR, including TFE/PMVE/Cure Site monomer in molar amounts of 69.4 TFE, 30.2 perfluoromethyl vinyl ether (PMVE) and 0.43 cure site monomer, wherein the cure site monomers in the polymers in the blend was CF₂═CFO(CF₂)₅CN. Polymers and similar materials like those of Polymer B are described and made set forth in U.S. Pat. Nos. 6,518,366 and 6,878,778, each of which is incorporated herein by reference with respect thereto.

The curative used for both perfluoropolymers in the blend was 4,4′-[2,2,2-Trifluoro-1-(trifluoromethyl) ethylidene]bis[N1-phenyl-1,2-benzenediamine] (“Nph-AF”) from Daikin Industries, Ltd. having the following structure:

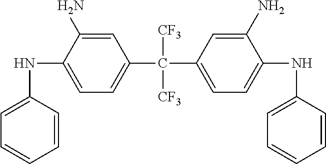

In the samples, Sample A included 50 parts per hundred parts base polymer of GA500 PR, 50 parts per hundred parts of base polymer of PFE 133 TZ and 1.6 parts per 100 parts by weight of base polymer of NPh-AF. No other additives were incorporated in the perfluoropolymer blend. The blend was compounded and formed into an extruded pre-form. The adhesive was brushed onto a metal substrate (aluminum plate) on one surface and allowed to dry. Then the FFKM/slabs were directly molded to bond the pre-form to the aluminum surface. The molding and testing thereof were done in accordance with American Standard Testing Method (ASTM) procedures, specifically ASTM-D429. The bonding agent was activated and the FFKM blended compositions were cured by subjected the pre-forms on the substrates to molding under a pressure of about 2,000 psi, and a pressing temperature of about 360° F. for about 30 minutes. The samples were subjected to post-curing processing AT 450° F. for 24 hours. The bond formed by the inventive sample showed higher bonding strength at all temperatures, and sustained bonding force at high temperatures. Bonding force was tested at room temperature (about 20° C.) to failure. The results are shown in Table 1 below.

TABLE 1

| | | |
|---|---|---|
| Sample No. | A | 1 |

Sample/Bonding Force (lb, Al Bonding insert)
Room Temperature Bonding Strength (lbs)

| | | |
|---|---|---|
| Trial 1 | 762.4 | 1431.0 |
| Trial 2 | 1508.0 | 1243.0 |
| Trial 3 | 1558.0 | 1434.0 |
| Trial 4 | 590.0 | 1507.0 |
| Average | 1104.6 | 1403.75 |
| Standard Deviation | 500.1 | 112.8 |

Bonding Strength @ 150° C./302° F.

| | | |
|---|---|---|
| Trial 1 | 90.7 | 264.7 |
| Trial 2 | 62.8 | 259.1 |
| Trial 3 | 66.0 | 268.9 |
| Trial 4 | 154.1 | 248.9 |
| Average | 93.4 | 260.4 |
| Standard Deviation | 42.3 | 8.7 |

Bonding Strength after Heat Aging in oven of 150° C.
for 70 h and testing at Room Temperature

| | |
|---|---|
| Trial 1 | 571.5 |
| Trial 2 | 1197.0 |
| Trial 3 | 758.4 |
| Trial 4 | 865.5 |
| Trial 5 | 698.5 |
| Trial 6 | 836.5 |
| Trial 7 | 637.0 |
| Trial 8 | 934.0 |
| Average | 812.3 |
| Standard Deviation | 196.7 |

The inventive example performed significantly better and provided less variability in performance both at room temperature and as temperature increased. The control composition had already deteriorated too much at 150° C. to test under heat aging.

The Example demonstrates that the invention provides high bonding strength for use in applications which are difficult, such as high-temperature environments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A bonding composition for bonding a curable fluoroelastomer composition to a substrate during a heat curing process, comprising
a) a compound selected from the group consisting of aluminum acrylates, silicon acrylates, ammonia acrylates, and combinations thereof,
b) an adhesive compound;
c) a solvent.

2. The bonding composition according to claim 1, wherein the adhesive compound is selected from the group consisting of epoxys, acrylates, urethanes, silicones, cyanoesters and combinations thereof.

3. The bonding composition according to claim 1, wherein there is only one of the compound and it is an aluminum acrylate, a silicon acrylate, or an ammonia acrylate.

4. The bonding composition according to claim 3, wherein the compound is aluminum acrylate.

5. The bonding composition according to claim 1, wherein a ratio of the compound to the adhesive compound in the composition is about 0.1:25 to about 2:1 parts by weight on a dry basis.

6. The bonding composition according to claim 5, wherein the ratio of the compound to the adhesive compound in the composition is about 1:5 to about 1:1 parts by weight on a dry basis.

7. The bonding composition according to claim 1, comprising about 20 to about 90 percent by weight solvent; about 0.4 to about 54 parts by weight of the compound and about 3 to about 78 parts by weight of the adhesive compound.

8. The bonding composition according to claim 1, wherein the composition is heavy-metal free.

9. The bonding composition according to claim 1, wherein the solvent is compatible with the compound and the adhesive compound.

10. The bonding composition according to 9, wherein the solvent is selected from the group consisting of acetone, methyl ethyl ketone, methyl isobutyl ketone, methanol, ethanol and propanol.

11. The bonding composition according to claim 1, wherein the solvent is vaporizable at temperatures of no greater than about 120° C.

12. The bonding composition according to claim 1, wherein the bonding composition is capable of bonding a fluoroelastomer composition to a substrate selected from the group consisting of ceramic, metals, metal alloys, semiconductors, polymers, and combinations thereof.

13. The bonding composition according to claim 1, wherein the bonding composition is capable of bonding a fluoroelastomer composition to alumina, sapphire, boron, yttria, silicon, germanium, arsenic, antimony, tellurium, polonium, anodized aluminum, aluminum, stainless steel, polytetrafluoroethylene, and combinations thereof.

14. The bonding composition according to claim 1, wherein the bonding composition is capable of bonding a fluoroelastomer composition to a substrate selected from the group consisting of ceramic, metals, metal alloys, semiconductors, polymers and combinations thereof.

15. The bonding composition according to claim 14, wherein the fluoroelastomer composition comprises a curable fluoroelastomer that has at least two monomers and at least one curesite monomer, wherein the at least two monomers comprise tetrafluoroethylene and vinylidene fluoride.

16. The bonding composition according to claim 15, wherein the fluoroelastomer composition comprises at least one curing agent.

17. The bonding composition according to claim 16, wherein the fluoroelastomer composition further comprises at least one of a second curing agent, a co-curing agent, and a cure accelerator.

18. The bonding composition according to claim 14, wherein the fluoroelastomer comprises at least two curable fluoropolymers.

19. The bonding composition according to claim 18, wherein the at least two curable fluoropolymers are in a blend.

20. The bonding composition according to claim 14, wherein the fluoropolymer composition is a perfluoropolymer composition and the least one curable fluoropolymer comprises at least one curable perfluoropolymer.

21. The bonding composition according to claim 20, wherein the curable perfluoroelastomer composition comprises at least one curing agent.

22. The bonding composition according to claim 20, wherein the curable perfluoropolymer comprises tetrafluoroethylene, a perfluoroalkylvinylether, and at least one curesite monomer.

23. The bonding composition according to claim 20, comprising at least two curable perfluoropolymers.

24. The bonding composition according to claim 23, wherein the perfluoropolymers are in a blend.

25. The bonding composition according to claim 24, wherein the perfluoropolymer composition comprises a first curable perfluoropolymer comprising tetrafluoroethylene, a first perfluoroalkylvinyl ether and at least one first cure site monomer having at least one cure site, wherein the tetrafluoroethylene is present in the first curable perfluoropolymer in an amount of at least about 60 mole percent; a second curable perfluoropolymer comprising tetrafluoroethylene, a second perfluoroalkylvinyl ether and at least one second cure site monomer having at least one cure site, wherein the second curable perfluoropolymer comprises fluoroplastic particles therein, and a curing agent.

26. The bonding composition according to claim 20, wherein the perfluoropolymer comprises at least 60 to 95 mole percent tetrafluoroethylene.

27. A method of bonding a fluoroelastomer composition to a substrate, comprising,
a) providing a curable fluoropolymer composition comprising at least one curable fluoropolymer;
b) forming an article pre-form having an outer surface;
b) providing a substrate having a bonding surface thereon;
c) coating at least one of a portion of the outer surface of the article pre-form and at least a portion of the bonding surface of the substrate with a bonding composition comprising a compound selected from the group consisting of aluminum acrylates, silicon acrylates, ammonia acrylates, and combinations thereof; an adhesive compound; and a solvent;
d) contacting the outer surface of the article pre-form and the substrate surface such that the bonding composition contacts at least a portion of the outer surface of the article pre-form and the substrate surface; and
e) subjecting the article-pre-form and the substrate to heat and curing the fluoropolymer composition so as to bond the article pre-form to the substrate surface by way of the bonding composition and form a bonded structure having a fluoroelastomer bonded to the substrate.

28. The method according to claim 27, wherein the fluoroelastomer composition is a perfluoroelastomer composition.

29. The method according to claim 27, further comprising
f) post-curing the bonded structure.

30. The method according to claim 27, wherein step b) further comprises providing a second substrate having a surface and step e) further comprises heat molding the curable fluoropolymer composition to the surface of the first substrate and to the surface of the second substrate to form a bonded structure, wherein the fluoropolymer is at least partially bonded to the surfaces of the first and the second substrates.

31. The method according to claim 30, wherein the bonded structure is a laminated structure.

32. A bonded structure, comprising:
a) a substrate having a surface; and
b) a fluoroelastomer bonded thereto, wherein the substrate and the fluoroelastomer are bonded by a bonding composition comprising a compound selected from the group consisting of aluminum acrylates, silicon acrylates, ammonia acrylates, and combinations thereof; an adhesive compound; and a solvent.

33. The bonded structure according to claim 32, wherein the fluoroelastomer is a perfluoroelastomer.
